(19) United States
(12) Patent Application Publication
(10) Pub. No.: US 2019/0279117 A1
(43) Pub. Date: Sep. 12, 2019

(54) SYSTEM AND METHOD FOR PROVIDING WAIT TIMES FOR TAXI QUEUEING AREAS

(71) Applicant: James P. Laverty, Freeport, NY (US)

(72) Inventor: James P. Laverty, Freeport, NY (US)

(21) Appl. No.: 15/913,351

(22) Filed: Mar. 6, 2018

(51) Int. Cl. G06Q 10/02; G07C 11/00; H04W 4/02

(52) U.S. Cl. CPC G06Q 10/02; G07C 2011/04; H04W 4/025; G07C 11/00

(57) ABSTRACT

A system for predicting wait times at taxi queueing areas. The system can include: (a) at least one handheld device having a wait-time software application installed thereon; and (b) a computer server, which computer server is coupled to the at least one handheld device and programmed to: (i) receive first data, the first data pertaining to a number of taxis within a queue of a particular taxi stand; (ii) receive second data, the second data pertaining to a number of customers waiting for a taxi at the particular taxi stand; (iii) calculate a wait time for a taxi entering the queue based on the first data and the second data; and (iv) transmit the wait time to the at least one handheld device.

### BACKGROUND

The subject matter described herein relates to system and method for providing wait times for taxi queueing areas, e.g., at airports and large hotels.

Driving a taxi is difficult in the sense that time without a customer is time that you are not being paid. To maximize profits, the taxi driver needs to anticipate where and when customers are most likely congregating to hail a taxi. One of areas is local airports and large hotels. Due to limited space at these facilities, the facilities set up taxi queuing areas when the number of taxis present exceed a certain number.

These taxi queuing areas can quickly become very full and once within a queue the taxi is unable to leave the taxi queueing area. Therefore, these wait times can be needlessly long and the taxi is without a customer for an extended period of time. Another problem with picking up customers near these taxi queuing areas is that these areas are sometimes a far distance from a city hub and driving to these areas can be take a long time, especially if traffic jams are encountered.

### SUMMARY

The disclosed technology relates to a system and method for providing, via a mobile device, wait times for taxi queueing areas at airports, large hotels/casinos, cruise ship ports or any taxi stand area where taxis are positioned in a queueing area. The disclosed technology offers a taxi driver estimated wait times in real-time or near-real time thereby allowing the taxi driver to maximize customer pickups and minimize idle standby times.

In one implementation, a system for predicting wait times at taxi queueing areas, the system can comprise: (a) at least one handheld device having a wait-time software application installed thereon; and (b) a computer server, which computer server is coupled to the at least one handheld device and programmed to: (i) receive first data, the first data pertaining to a number of taxis within a queue of a particular taxi stand; (ii) receive second data, the second data pertaining to a number of customers waiting for a taxi at the particular taxi stand; (iii) calculate a wait time for a taxi entering the queue based on the first data and the second data; and (iv) transmit the wait time to the at least one handheld device.

In some implementations, the first data can be obtained using a first counter. In some implementations, the second data can be obtained using a second counter. In some implementations, the wait time can be transmitted to the at least one handheld device upon request of the driver.

In some implementations, the computer server can be further programmed deteunining a present location of the at least one handheld device. In some implementations, the wait time can be transmitted to the at least one handheld device when in dose proximity to the particular taxi stand.

In some implementations, the computer server can be further programmed to: populating a list of one or more taxi stands having short wait times; and estimating travel times to one or more taxi stands from the present location. In some implementations, the computer server can be further programmed to: populating a list of taxi stands that offer the best chances of picking up a customer within the shortest amount of travel and queue time.

The advantage of the disclosed technology is that it solves a taxi driver's guess work as to which taxi stand has customers and which wait times are lowest thereby maximizing taxi profits.

### BRIEF DESCRIPTION OF THE DRAWINGS

FIG. 1 shows a flow chart illustrating an example of the disclosed technology; and

FIG. 2 shows a schematic diagram of an example of the disclosed technology.

### DETAILED DESCRIPTION

The disclosed technology relates to a system and method for providing, via a mobile computing device, wait times for taxi queueing areas at airports, large hotels/casinos, cruise ship ports or any taxi stand areas where taxis are placed in queue.

The mobile computing device can be a laptop, a smartphone, a tablet or any other mobile computing device capable of connecting to a mobile or wireless network.

It should be noted that the disclosed system and method can be implemented on a computing device separate from handheld devices, or the functionality of the disclosed system and method can be implemented completely, or partially, on handheld devices, as desired. For purposes of the present discussion, the functionality of the disclosed system and method will be described as a system having servers connected to handheld devices through a network. Of course, other embodiments can be used as well.

The disclosed system and method can be part of a downloadable application for a mobile device, e.g., smartphone or can be accessed via a webpage. The term “application” as used herein refers to a computer software application, otherwise known as an “app” that is run and operated on a mobile device.

The app can allow taxi drivers to register and participate in a taxi driver program. A taxi driver can register with the application by providing a name, age, e-mail address, sex, etc. A driver number can be granted for a valid registration or the taxi driver can create a driver profile using a unique driver ID.

The taxi driver data can be stored in a database associated with a server. The server can be remote from the mobile device. The mobile device can link with the server using a mobile or wireless network connection.

In order to determine taxi stand wait times, the number of taxis in a queue at a taxi stand is cross-referenced with a number of people in line at the taxi stand. A calculation is performed that gives the amount of time the last taxi in the queue will be able to allow a paying customer to board the taxi. This calculation is based on many factors dependent on the type of taxi stand and the distance the queue is from the pickup point.

Once calculated, these times are posted on the mobile app or webpage so that a driver can see the wait time before deciding to drive to a particular taxi stand.

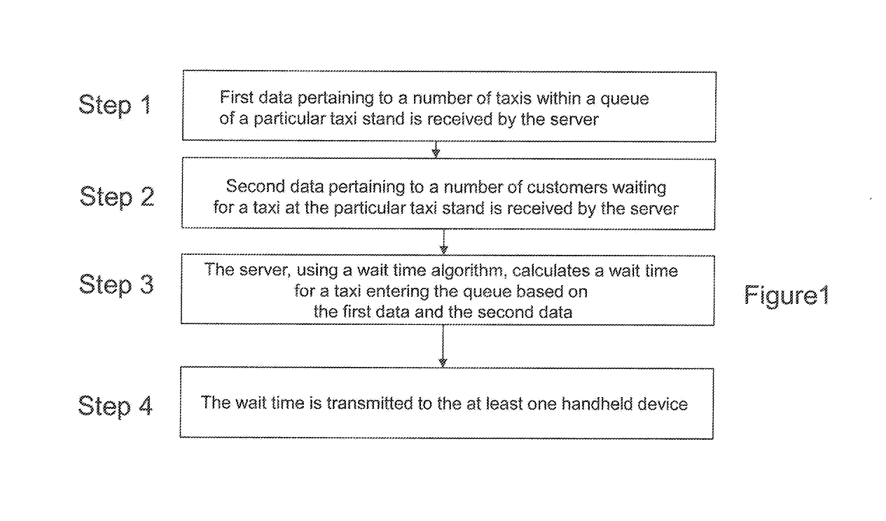

FIG. 1 is a flow chart showing an example of the disclosed technology. First data pertaining to a number of taxis within a queue of a particular taxi stand is received b the server (Step 1). Second data pertaining to a number of customers waiting for a taxi at the particular taxi stand is received by the server (Step 2). The server, using a wait-time algorithm, calculates a wait time for a taxi entering the queue based on the first data and the second data (Step 3). The wait time is transmitted to the at least one handheld device (Step 4).

In some implementations, first data and second data can be transmitted to the server via a counter, e.g., a smart camera having counting capabilities, facial and license plate recognition software, manually input or any other means in which a count can be performed and the count sent to the server. These counters can be remotely connected to the server over a wired or wireless connection.

The wait time algorithm calculates wait times using the number of taxis in a queue at a taxi stand, a number of customers in line at the taxi stand and taxi stand specific criterion, e.g., the time needed to travel from queue to taxi stand, the amount of taxi spaces available at the taxi stand and any other taxi stand specific criterion needed for the calculation. These taxi stand specific criterion can be saved in a database for use by the wait time algorithm.

In another implementation, the application can be in electronic communication with a GPS in the mobile device and can thus automatically obtain location information of the taxi. The application can actively receive taxi stands in close proximity to the taxi with low wait times. For example, when driving in a vicinity of a taxi stand, an alert can be activated on a mobile device and a wait time can be displayed on the screen of the mobile device. The alert can be an alarm, a noise, a vibration, a visual display or combinations thereof. In some implementations, the present location can be manually input by the driver, e.g., enter zip code or cross streets. If a general location is input, a list of nearby taxi stand wait times can appear.

In another implementation, the system and method can be capable of estimating which taxi stands would be most efficient for a driver to drive to from a present location by using (1) a present location of a taxi, (2) a location of one or more taxi stands having short wait times and (3) estimated travel times to the one or more taxi stands from the present location using conventional mapping/traffic techniques. Using these variables, the driver can be given of list of taxi stands that offer the best chances of picking up a customer within the shortest amount of travel and queue time.

The disclosed technology can identify the location of the taxi utilizing the wait time software application. The location system can be any conventional locating system. A location component can include a global positioning system that periodically updates geographic position information using at least longitude and latitude that indicates the location of the handheld device in which the app is installed. The location component can be turned on/off by user or run in background.

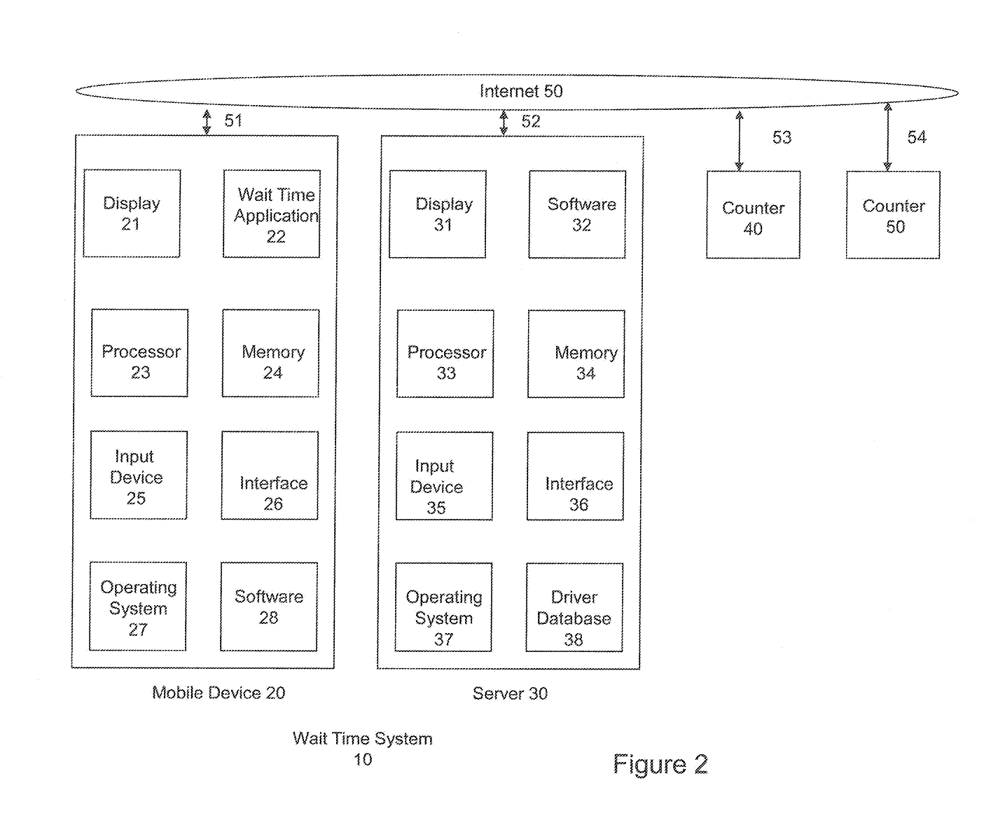

FIG. 2 is a schematic diagram of an example of a wait time system 10. The wait time system includes a mobile device 20, a server 30 and counters 40, 50. For ease of explanation only one of each device is shown bat more than one of each is contemplated.

The mobile device 20 includes a display 21, a wait time application 22, a processor 23, a memory 24, an input device 25, an interface 26, an operating system 27 and software 28.

The server 30 includes a display 31, application software 32, a processor 33, a memory 34, an input device 35, an interface 36, an operating system 37 and driver database 38.

The mobile devices 20, server 30 and counters 40, 50 can be connected to one another over the internet 50 via connections 51-54 but other more secure connections are contemplated.

In some implementations, the system of FIG. 2 can be split into a mobile device-server environment communicatively connected over the internet 50 with connectors 51, 52 where the server 30 can include hardware as shown in FIG. 2 and also code for calculating wait times, code for counting customers at a taxi stand, code for counting taxis within a queue, code for notification functions, code for location services and code for mapping functions.

The operating systems 27, 37 can be multi-user, multiprocessing, multitasking, multithreading, real-time and the like. The operating systems 27, 37 may perform basic tasks, including but not limited to: recognizing input from input devices 25, 35; sending output to display devices 21, 31; keeping track of files and directories on computer-readable mediums 24, 34 (e.g., memory or a storage device); controlling peripheral devices (e.g., disk drives, printers, etc.); and managing traffic on the one or more buses 51, 52, 53, 54.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on a computer storage media for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer storage medium can be, or be included in, a computer-readable storage device, a computer-readable storage substrate, a random or serial access memory array or device, or a combination of one or more of them.

The operations described in this specification can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or combinations of them. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, e.g., a virtual machine, or a combination of one or more of them. The apparatus and execution environment can realize various different computing model infrastructures, e.g., web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

The foregoing Detailed Description is to be understood as being in every respect illustrative and exemplary, but not restrictive, and the scope of the disclosed technology disclosed herein is not to be determined from the Detailed Description, but rather from the claims as interpreted according to the fall breadth permitted by the patent laws. It is to be understood that the embodiments shown and described herein are only illustrative of the principles of the disclosed technology and that various modifications may be implemented by those skilled in the art without departing from the scope and spirit of the disclosed technology. Those skilled in the art could implement various other feature combinations without departing from the scope and spirit of the disclosed technology. Although the embodiments of the present disclosure have been described with specific examples, it is to be understood that the disclosure is not limited to those specific examples and that various other changes, combinations and modifications will be apparent to one of ordinary skill in the art without departing from the scope and spirit of the disclosed technology which is to be determined with reference to the following claims.

1. A system for predicting wait times at taxi queueing areas, the system comprising:
(a) at least one handheld device having a wait-time software application installed thereon; and
(b) a computer server, which computer server is coupled to the at least one handheld device and programmed to:
(i) receive first data, the first data pertaining to a number of taxis within a queue of a particular taxi stand;
(ii) receive second data, the second data pertaining to a number of customers waiting for a taxi at the particular taxi stand;
(iii) calculate a wait time for a taxi entering the queue based on the first data and the second data: and
(iv) transmit the wait time to the at least one handheld device.

2. The system of claim 1 wherein the first data is obtained using a first counter.

3. The system of claim 1 wherein the second data is obtained using a second counter.

4. The system of claim 1 wherein the wait time is automatically transmitted to the at least one handheld device.

5. The system of claim 1 wherein the wait time is transmitted to the at least one ham held device upon request of a driver.

6. The system of claim 1 wherein the computer server is further programmed to:
determining a present location of the at least one handheld device.

7. The system of claim 1, wherein the wait time is transmitted to the at least one handheld device when in close proximity to the particular taxi stand.

8. The system of claim 6 wherein the computer server is further programmed to:
populating a list of one or more taxi stands having short wait times; and
estimating travel times to one or more taxi stands from the present location.

9. The system of claim 8 wherein the computer server is further programmed to:
populating a list of taxi stands that offer the best chances of picking up a customer within the shortest amount of travel and queue time.
